(19) United States
(12) Patent Application Publication
(10) Pub. No.: US 2024/0272607 A1
(43) Pub. Date: Aug. 15, 2024

(54) CONTROL DEVICE FOR INDUSTRIAL MACHINE

(71) Applicant: Fanuc Corporation, Minamitsuru-gun, Yamanashi (JP)

(72) Inventor: Hideo Ogino, Minamitsuru-gun, Yamanashi (JP)

(73) Assignee: Fanuc Corporation, Minamitsuru-gun, Yamanashi (JP)

(21) Appl. No.: 18/561,409

(22) PCT Filed: May 25, 2021
(86) PCT No.: PCT/JP2021/019884

§ 371 Date: Nov. 16, 2023

(51) Int. Cl. G05B 19/4068; G05B 19/409

(52) U.S. Cl. CPC G05B 19/4068; G05B 19/409; G05B 2219/35472; G05B 2219/36168

(57) ABSTRACT

This control device includes: an image display unit that displays, on a display screen, an operation image for changing a driving mode of a driving axis; a determination unit that determines the driving mode on the basis of an operation on the operation image; and a control unit that controls the driving axis on the basis of the driving mode determined by the determination unit.

### CROSS REFERENCE TO RELATED APPLICATIONS

This is the U.S. National Phase application of PCT/JP2021/019884, filed May 25, 2021, the disclosure of this application being incorporated herein by reference in its entirety for all purposes.

### FIELD OF THE INVENTION

The present disclosure relates to a controller for an industrial machine.

### BACKGROUND OF THE INVENTION

A control panel of a controller that controls an industrial machine is provided with a setting switch for setting a driving mode of an axis (for example, Patent Document 1 and Patent Document 2).

### PATENT DOCUMENT

Patent Document 1: JP S56-56302 A
Patent Document 2: JP 5766762 B2

### SUMMARY OF THE INVENTION

However, when the control panel is provided with a dedicated setting switch for setting a driving mode of each axis, manufacturing costs of the control panel increase.

An object of the disclosure is to provide a controller for an industrial machine that can reduce the manufacturing costs of the control panel.

A controller includes an image display unit configured to display an operation image for changing a driving mode of a driving axis on a display screen, a determination unit configured to determine the driving mode based on an operation on the operation image, and a control unit configured to control the driving axis based on the driving mode determined by the determination unit.

According to one aspect of the disclosure, it is possible to reduce manufacturing costs of the control panel of the controller.

### BRIEF DESCRIPTION OF DRAWINGS

FIG. 1 is a block diagram illustrating an example of a hardware configuration of a controller;

FIG. 2 is a block diagram illustrating an example of functions of the controller;

FIG. 3A is a diagram illustrating an example of a driving axis information image;

FIG. 3B is a diagram illustrating an example of an operation image;

FIG. 3C is a diagram for describing an example of an operation on the operation image;

FIG. 3D is a diagram illustrating an example of the operation image and the driving axis information image;

FIG. 3E is a diagram for describing an example of a candidate image display region;

FIG. 3F is a diagram illustrating an example of the operation image and the driving axis information image;

FIG. 3G is a diagram for describing an example of an operation on the operation image;

FIG. 4 is a flowchart illustrating an example of a flow of processing executed by a controller;

FIG. 5A is a diagram for describing an example of an operation on the operation image;

FIG. 5B is a diagram illustrating an example of the operation image and the driving axis information image;

FIG. 5C is a diagram for describing an example of an operation on the operation image;

FIG. 5D is a diagram illustrating an example of the operation image and the driving axis information image;

FIG. 6A is a diagram illustrating an example of the driving axis information image;

FIG. 6B is a diagram illustrating an example of the operation image and an axis specification image;

FIG. 6C is a diagram illustrating an example of the operation image and the axis specification image;

FIG. 6D is a diagram illustrating an example of the operation image and the axis specification image; and

FIG. 6E is a diagram illustrating an example of the driving axis information image.

### DETAILED DESCRIPTION OF EMBODIMENTS OF THE INVENTION

An embodiment of the disclosure will be described below with reference to the drawings. Note that not all combinations of features described in the following embodiment are necessarily required to solve the problem. In addition, more detailed description than necessary may be omitted. Further, the following description of the embodiment and drawings are provided for a full understanding of the disclosure by those skilled in the art and are not intended to limit the scope of the claims.

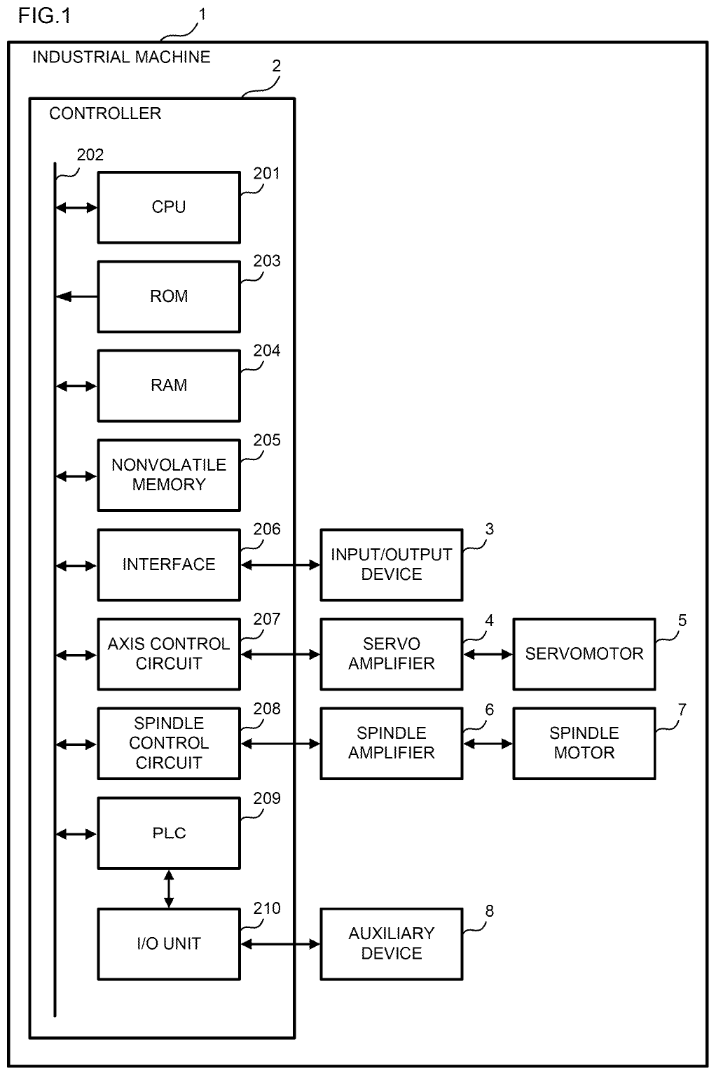

FIG. 1 is a diagram illustrating an example of a hardware configuration of an industrial machine. For example, the industrial machine 1 is a machine tool, a wire electric discharge machine, or a robot. The machine tool includes a lathe, a machining center, and a multi-tasking machine. For example, the robot is an industrial robot such as a manipulator.

The industrial machine 1 includes a controller 2, an input/output device 3, a servo amplifier 4 and a servomotor 5, a spindle amplifier 6 and a spindle motor 7, and an auxiliary device 8.

The controller 2 is a device that controls the entire industrial machine 1. The controller 2 is, for example, a numerical controller that controls the industrial machine 1. The controller 2 includes a CPU (Central Processing Unit) 201, a bus 202, a ROM (Read Only Memory) 203, a RAM (Random Access Memory) 204, and a nonvolatile memory 205.

The CPU 201 is a processor that controls the entire controller 2 according to a system program. The CPU 201 reads a system program, etc. stored in the ROM 203 via the bus 202 and performs various processes based on the system program. In addition, the CPU 201 controls the servomotor 5 and the spindle motor 7 based on a machining program.

For example, the CPU 201 analyzes the machining program and outputs control commands to the servomotor 5 and the spindle motor 7 for each control cycle.

The bus 202 is a communication path that connects respective pieces of hardware in the controller 2 to each other. The respective pieces of hardware in controller 2 exchange data via the bus 202.

The ROM 203 is a storage device that stores a system program, etc. for controlling the entire controller 2. The ROM 203 is a computer-readable storage medium.

The RAM 204 is a storage device that temporarily stores various data. The RAM 204 functions as a working area for the CPU 201 to process various data.

The nonvolatile memory 205 is a storage device that retains data even in a state in which the power of the industrial machine 1 is turned off and power is not supplied to the controller 2. The nonvolatile memory 205 stores, for example, a machining program and various parameters input from the input/output device 3. The nonvolatile memory 205 is a computer-readable storage medium. The nonvolatile memory 205 includes, for example, an SSD (Solid State Drive).

The controller 2 further includes an interface 206, an axis control circuit 207, a spindle control circuit 208, a PLC (Programmable Logic Controller) 209, and an I/O unit 210.

The interface 206 connects the bus 202 and the input/output device 3 to each other. For example, the interface 206 transmits various data processed by the CPU 201 to the input/output device 3.

The input/output device 3 is a device that receives various data via the interface 206 and displays the various data. In addition, the input/output device 3 receives input of various data and transmits the various data to the CPU 201 via the interface 206. The input/output device 3 is, for example, a touch panel. When the input/output device 3 is a touch panel, the touch panel is, for example, a capacitive-type touch panel. Note that the touch panel is not limited to the capacitive type, and may be a touch panel of another type. The input/output device 3 is attached to, for example, a control panel (not illustrated) in which the controller 2 is stored.

The axis control circuit 207 is a circuit that controls the servomotor 5. The axis control circuit 207 receives a control command from the CPU 201 and outputs a command for driving the servomotor 5 to the servo amplifier 4. For example, the axis control circuit 207 transmits a torque command for controlling torque of the servomotor 5 to the servo amplifier 4.

The servo amplifier 4 receives a command from the axis control circuit 207 and supplies current to the servomotor 5.

The servomotor 5 is driven by being supplied with current from the servo amplifier 4. For example, the servomotor 5 is coupled to a ball screw that drives a tool post. By driving the servomotor 5, for example, a structure of the industrial machine 1 such as the tool post moves in an X-axis direction, a Y-axis direction, or a Z-axis direction. Note that the servomotor 5 may incorporate a speed detector (not illustrated) that detects a feed rate of each feed axis.

The spindle control circuit 208 is a circuit for controlling the spindle motor 7. The spindle control circuit 208 receives a control command from the CPU 201 and outputs a command for driving the spindle motor 7 to the spindle amplifier 6. For example, the spindle control circuit 208 transmits a torque command for controlling torque of the spindle motor 7 to the spindle amplifier 6.

The spindle amplifier 6 receives a command from the spindle control circuit 208 and supplies current to the spindle motor 7.

The spindle motor 7 is driven by being supplied with current from the spindle amplifier 6. The spindle motor 7 is coupled to the spindle and rotates the spindle.

The PLC 209 is a device that executes a ladder program to control the auxiliary device 8. The PLC 209 transmits a command to the auxiliary device 8 via the I/O unit 210.

The I/O unit 210 is an interface that connects the PLC 209 and the auxiliary device 8 to each other. The I/O unit 210 transmits a command received from the PLC 209 to the auxiliary device 8.

The auxiliary device 8 is a device that is installed in the industrial machine 1 and performs an auxiliary operation in the industrial machine 1. The auxiliary device 8 may be a device installed around the industrial machine 1. The auxiliary device 8 operates based on a command received from the I/O unit 210. The auxiliary device 8 is, for example, a tool changer, a cutting fluid injection device, or an opening/closing door driving device. Next, an example of functions of the controller 2 will be described.

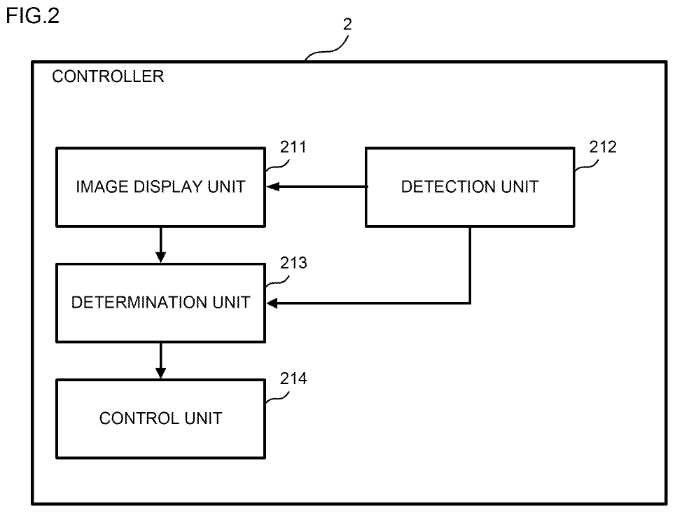

FIG. 2 is a block diagram illustrating an example of functions of the controller 2. The controller 2 includes an image display unit 211, a detection unit 212, a determination unit 213, and a control unit 214. For example, the image display unit 211, the detection unit 212, the determination unit 213, and the control unit 214 are realized by the CPU 201 performing arithmetic processing using a system program stored in the ROM 203 and various data stored in the nonvolatile memory 205.

The image display unit 211 displays a driving axis information image indicating driving axis information of a driving axis on a display screen. The driving axis is an axis for driving each unit of the industrial machine 1. For example, the driving axis includes feed axes such as an X-axis, a Y-axis, and a Z-axis. Furthermore, the driving axis may include rotating axes such as an A-axis, a B-axis, and a C-axis. In addition, the driving axis may include the spindle. For example, the display screen is a display screen of the input/output device 3.

The driving axis information includes an axis name of the driving axis. In addition, the driving axis information includes coordinate values of each axis in a predetermined coordinate system. For example, the predetermined coordinate system is an absolute coordinate system of the industrial machine 1. The predetermined coordinate system may be a machine coordinate system of the industrial machine 1.

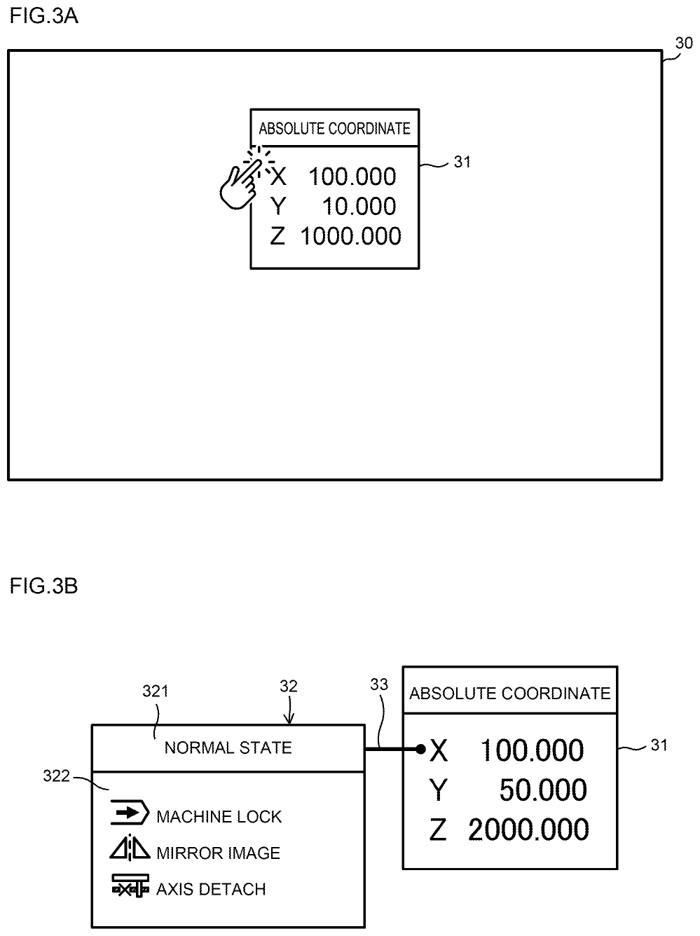

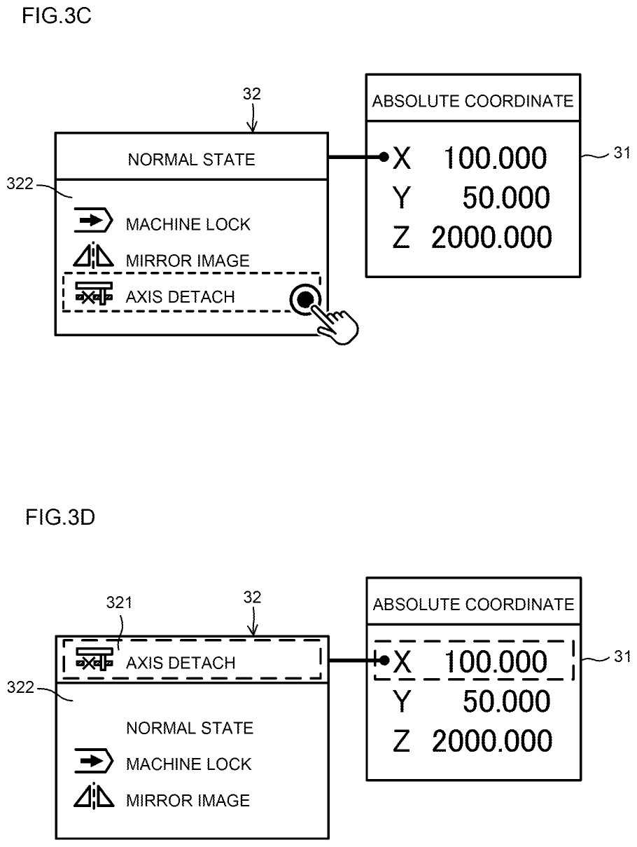

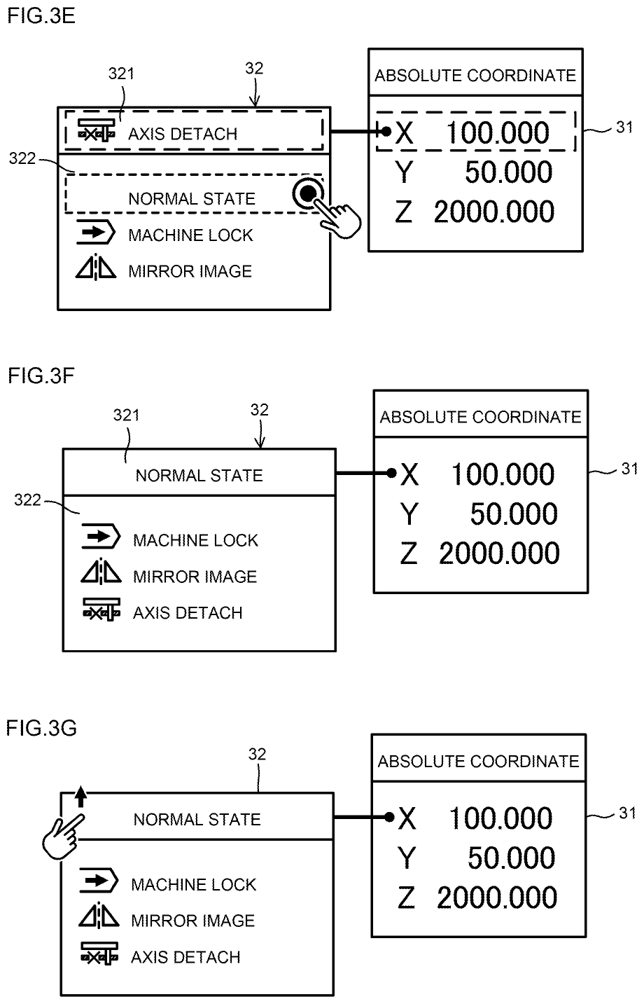

FIG. 3A is a diagram illustrating an example of the driving axis information image displayed on the display screen. A driving axis information image 31 illustrated in FIG. 3A indicates coordinate values of the X-axis, the Y-axis, and the Z-axis in the absolute coordinate system.

Incidentally, in FIG. 3A, a figure simulating a hand indicates that the driving axis information image 31 is touch-operated, and is not displayed on the display screen 30. Similarly, a figure simulating a hand drawn in each figure to be described later is not displayed on the display screen 30.

The detection unit 212 detects a touch operation on the display screen 30. The detection unit 212 detects a touch operation on the driving axis information image 31. The touch operation on the driving axis information image 31 may be an operation of touching the vicinity of the driving axis information image 31 in addition to an operation of touching the driving axis information image 31.

For example, the detection unit 212 detects a touch operation on a region displaying the axis name included in the driving axis information image 31 or a region near the region. In the example illustrated in FIG. 3A, the detection unit 212 detects a touch operation on a region displaying a character “X” indicating the name of the X-axis.

The touch operation includes a tap operation. In addition, the touch operation may be a long press operation or a slide operation. The tap operation may be a plurality of tap operations. The touch operation is an operation using a finger of an operator. In addition, the touch operation may be an operation using a touch pen.

When the detection unit 212 detects a touch operation on the display screen 30, the image display unit 211 displays an operation image on the display screen 30.

The operation image is an image for changing a driving mode of the driving axis. The driving mode means a setting state of the driving axis. In other words, behavior of the driving axis and controller 2 in response to movement commands is determined according to a set driving mode. For example, the driving mode includes a normal mode, a machine lock mode, a mirror image mode, an axis detach mode, an interlock mode, and a servo off mode.

The normal mode is a mode set when the industrial machine 1 performs a normal operation. For example, the normal mode is a mode set when a workpiece is machined.

The machine lock mode is a mode in which movement of the driving axis is locked not to operate the driving axis, and coordinate values of the locked driving axis are not updated in the machine coordinate system and updated in the absolute coordinate system. For this reason, the machine lock mode is used, for example, during program check.

The mirror image mode is a mode in which each driving axis is reversed and operated. For example, when a command for operating the driving axis in a positive direction of the X-axis is executed, the driving axis operates in a negative direction of the X-axis in the mirror image mode.

The axis detach mode is a mode in which an alarm is not issued even in a state in which the driving axis is detached from the industrial machine 1. In other words, in the axis detach mode, a target driving axis is excluded from a control target. For example, during maintenance work on the industrial machine 1, the axis detach mode is used when operations of the X-axis, the Y-axis, and the Z-axis are checked in a state in which the rotating axes such as the A-axis and the B-axis are detached.

The interlock mode is a mode in which operations between devices are interlocked to ensure safety. In the interlock mode, for example, the driving axis operates only when a door is in a closed state.

The servo off mode is a mode in which the servomotor for driving the target driving axis is not energized. In the servo off mode, the target driving axis is in a free state. For example, when the X-axis is set to the servo off mode, a table can be moved along the X-axis by manually pushing the table.

The image display unit 211 displays an axis specification image together with the operation image on the display screen 30. The axis specification image is an image for specifying a driving axis subjected to mode change.

FIG. 3B is a diagram illustrating an example of the operation image and the axis specification image. The operation image 32 is displayed adjacent to the driving axis information image 31. In other words, the image display unit displays the operation image and the driving axis information image 31 side by side. In this case, the operation image and the driving axis information image 31 may be displayed partially overlapping each other. Alternatively, the images may be displayed so that one end of the operation image and one end of the driving axis information image 31 contact each other. Alternatively, the operation image and the driving axis information image 31 may be separately displayed. The operation image 32 includes a setting mode display region 321 and a candidate image display region 322.

The setting mode display region 321 is a region in which an image indicating a currently set driving mode is displayed. In the example illustrated in FIG. 3B, characters “normal state” indicating the normal mode is displayed in the setting mode display region 321. In this way, the operator can recognize that the currently set driving mode is the normal mode. Note that, when the characters “normal state” are displayed in the setting mode display region 321, for example, a background of the setting mode display region 321 is displayed in white.

The candidate image display region 322 is a region in which an image indicating a candidate for the driving mode to be set is displayed. One or a plurality of images indicating a type of driving mode is displayed in the candidate image display region 322. For example, the candidate image display region 322 is disposed below the setting mode display region 321.

In the example illustrated in FIG. 3B, characters “machine lock” indicating the machine lock mode, characters “mirror image” indicating the mirror image mode, and characters “axis detach” indicating the axis detach mode are displayed in the candidate image display region 322. At this time, for example, the background of the candidate image display region 322 is displayed in gray.

The axis specification image 33 is an image for specifying a driving axis subjected to mode change. In the example illustrated in FIG. 3B, the axis specification image 33 is a line segment extending leftward in a horizontal direction from a position of “X” of the driving axis information image 31. In this way, the operator can recognize that the driving axis subjected to mode change is the X-axis.

The detection unit 212 detects a touch operation on an image displayed in the candidate image display region 322. The touch operation detected by the detection unit 212 is, for example, a long press operation, a tap operation, or a slide operation.

FIG. 3C is a diagram illustrating an example of the touch operation on the image displayed in the candidate image display region 322. The example illustrated in FIG. 3C illustrates that a long press operation is performed on the characters “axis detach”. For example, when the image displayed in the candidate image display region 322 is touched, the image display unit 211 changes the background of the candidate image display region 322 from gray to yellow.

When the finger is separated from the display screen 30 after a predetermined time has elapsed in a state in which the image is touched, the image display unit 211 displays the touched image in the setting mode display region 321. That is, when the detection unit 212 detects the long press operation on the image displayed in the candidate image display region 322, the image display unit 211 displays the touched image in the setting mode display region 321.

FIG. 3D is a diagram illustrating an example of the operation image 32 and the driving axis information image 31. FIG. 3D illustrates the operation image 32 and the driving axis information image 31 after the long press operation is performed on the image displayed in the candidate image display region 322. The characters “axis detach” long-pressed by the operator is displayed in the setting mode display region 321. Meanwhile, the characters “normal state” indicating the normal mode is displayed in the candidate image display region 322.

The image display unit 211 highlights and displays the image displayed in the setting mode display region 321. Highlight display may be a display mode in which an image subjected to the touch operation and an image not subjected to the touch operation are distinguished from each other. For example, the image display unit 211 displays a background of the image displayed in the setting mode display region 321 in green. In this way, the operator can easily recognize the set driving mode.

In addition, when the set driving mode is a driving mode other than the normal mode, the image display unit 211 highlights and displays an axis name and coordinate values of a driving axis set to the mode other than the normal mode. The image display unit 211 displays a background of the axis name and the coordinate values of the driving axis in green.

The determination unit 213 determines a driving mode based on an operation on the operation image 32. The determination unit 213 determines a driving mode to be set based on a touch operation on the display screen 30 detected by the detection unit 212. For example, as illustrated in FIG. 3C and FIG. 3D, when the detection unit 212 detects a long press operation on the characters “axis detach”, that is, an operation of selecting the axis detach mode, the determination unit 213 determines to set the driving mode to the axis detach mode.

The control unit 214 controls the driving axis based on the driving mode determined by the determination unit 213. For example, when the driving mode is set to the normal mode, the control unit 214 operates the driving axis based on a command with respect to the driving axis. In addition, when the driving mode is set to the machine lock mode, the control unit 214 does not operate the driving axis even when a command with respect to the driving axis is executed.

When the driving mode is set to the normal mode again, a touch operation is performed on the characters “normal state” displayed in the candidate image display region 322.

FIG. 3E is a diagram illustrating an example of an operation on an image displayed in the candidate image display region 322. FIG. 3E illustrates that a touch operation is performed on the characters “normal state”. When the characters “normal state” is touched, the image display unit 211 changes the background of the candidate image display region 322 from gray to yellow.

When the finger is separated from the display screen 30 after a predetermined time has elapsed in a state in which the characters “normal state” is touched, the image display unit 211 displays the touched characters “normal state” in the setting mode display region 321. That is, when the detection unit 212 detects the long press operation on the characters “normal state”, the image display unit 211 displays the touched characters “normal state” in the setting mode display region 321.

FIG. 3F is a diagram illustrating an example of the operation image 32 and the driving axis information image 31. FIG. 3F illustrates the operation image 32 and the driving axis information image 31 after a long press operation is performed on the characters “normal state”. The characters “normal state” subjected to the long press operation by the operator is displayed in the setting mode display region 321. Meanwhile, the characters “axis detach” is displayed in the candidate image display region 322.

In the case of displaying the characters “normal state” in the setting mode display region 321, the image display unit 211 displays a background of the setting mode display region 321 in white. In addition, in the case of displaying the characters “axis detach” in the candidate image display region 322, the image display unit 211 cancels highlight display of the characters “axis detach”. That is, the image display unit 211 returns the background of the characters “axis detach” displayed in the candidate image display region 322 to gray. In addition, the image display unit 211 returns the background of the axis name and the coordinate values of the driving axis to gray.

When an operation of eliminating the operation image 32 is performed, or when there is no operation on the operation image 32 for a predetermined time, the determination unit 213 determines to hide the operation image 32.

FIG. 3G is a diagram for describing an example of the operation on the operation image 32. When an operation of eliminating the operation image 32 is performed, the determination unit 213 determines to hide the operation image 32. For example, the elimination operation is a flick operation. In this way, the image display unit 211 eliminates the operation image 32 together with the axis specification image 33 from the display screen 30. A direction of the flick operation may be any direction. Note that the flick operation is an operation of rapidly moving a finger on the display screen 30 or an operation flicking the display screen 30. In addition, when there is no operation on the operation image 32 for, for example, 20 seconds, the determination unit 213 determines to hide the operation image 32.

Next, a description will be given of a flow of processing executed when the controller 2 changes the driving mode.

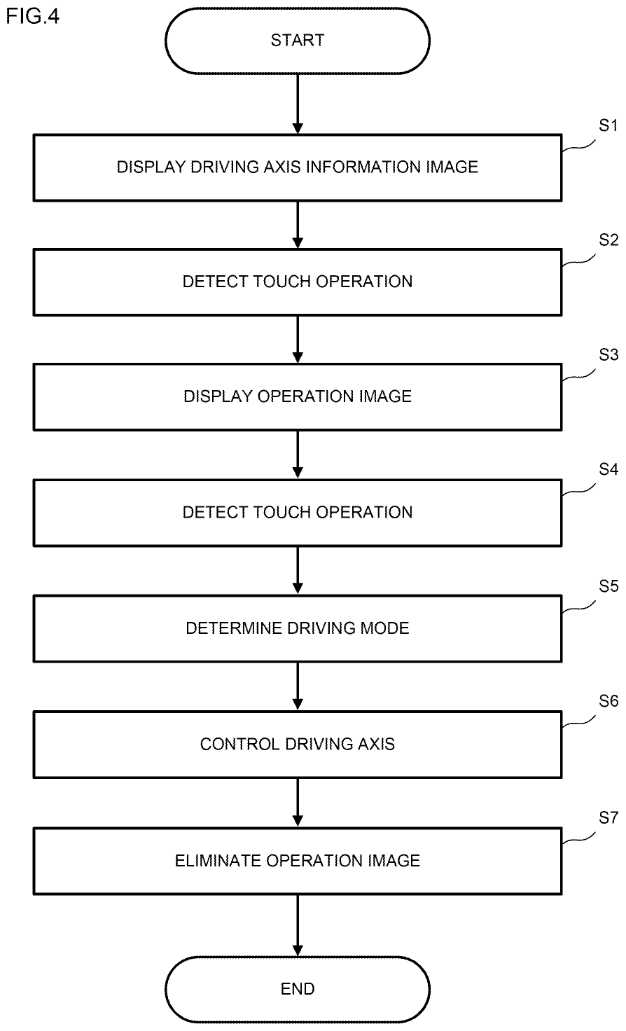

FIG. 4 is a flowchart illustrating an example of the flow of processing executed by the controller 2. In the controller 2, first, the image display unit 211 displays the driving axis information image 31 on the display screen 30 (step S1).

Next, when the operator performs a touch operation on the display screen 30, the detection unit 212 detects the touch operation on the display screen 30 (step S2). At this time, for example, the detection unit 212 detects a touch operation on the driving axis information image 31.

When the detection unit 212 detects the touch operation on the display screen 30, the image display unit 211 displays the operation image 32 on the display screen 30 (step S3).

When the operator performs a touch operation on the operation image 32, the detection unit 212 detects the touch operation on the operation image 32 (step S4).

Next, the determination unit 213 determines the driving mode based on the touch operation on the operation image 32 detected by the detection unit 212 (step S5).

Next, the control unit 214 controls the driving axis based on the driving mode determined by the determination unit 213 (step S6).

When the operation of determining the driving mode ends, the image display unit 211 eliminates the operation image 32 (step S7). The image display unit 211 eliminates the operation image 32, for example, when there is no touch operation on the operation image 32 for a predetermined time (step S7).

As described above, the controller 2 includes the image display unit 211 that displays the operation image 32 for changing the driving mode of the driving axis on the display screen 30, the determination unit 213 that determines the driving mode based on an operation on the operation image 32, and the control unit 214 that controls the driving axis based on the driving mode determined by the determination unit 213.

Therefore, there is no need to install a dedicated switch for setting the driving mode of the driving axis on the control panel of controller 2, and the costs of controller 2 can be reduced. In addition, the number of parts of the control panel can be reduced, assembly of the control panel is facilitated, and an assembly time of the control panel can be reduced. In addition, design changes of the display mode of the operation image 32, etc. can be facilitated. In this case, for example, the display mode can be designed according to a model of the industrial machine 1.

In addition, the controller 2 further includes the detection unit 212 that detects a touch operation on the display screen 30, and when the detection unit 212 detects a touch operation, the image display unit 211 displays the operation image 32 on the display screen 30. Therefore, the operation image 32 can be displayed on the display screen 30 only when the operation for changing the driving mode is necessary. In other words, it is possible to prevent the display screen 30 from becoming overloaded with information and improve visibility of the display screen 30.

In addition, the image display unit 211 further displays the driving axis information image 31 indicating driving axis information of the driving axis, and when the detection unit 212 detects a touch operation on the driving axis information image 31, the image display unit 211 displays the operation image 32 on the display screen 30. In addition, the image display unit 211 displays the operation image 32 adjacent to the driving axis information image 31. Therefore, the operator can visually recognize the driving axis information image 31 and the operation image 32 at the same time. Alternatively, the operator does not have to move a line of sight significantly between the driving axis information image 31 and the operation image 32. Therefore, it is possible to reduce the burden on the operator in an operation of setting the driving mode of the driving axis.

In addition, the image display unit 211 changes the display mode of the driving axis information image 31 based on the driving mode determined by the determination unit 213. Therefore, the operator can easily recognize the set driving mode.

In addition, when an operation of eliminating the operation image 32 is performed, or when there is no operation on the operation image 32 for a predetermined time, the determination unit 213 determines to hide the operation image 32. Therefore, only necessary information can be displayed on the display screen 30. That is, it is possible to prevent the display screen 30 from becoming overloaded with information.

In addition, the determination unit 213 determines the driving mode to be at least one of the normal mode, the machine lock mode, the mirror image mode, the axis detach mode, the interlock mode, and the servo off mode. Therefore, it is unnecessary to provide a switch for setting a plurality of driving modes on the control panel, and the manufacturing costs of the control panel can be reduced. In addition, operability of the control panel is improved.

In addition, the operation image 32 includes the axis specification image 33 for specifying the driving axis and the image indicating the candidate for the driving mode. In addition, the determination unit 213 determines the driving mode of the driving axis based on an operation on the image indicating the candidate. Therefore, the operator can easily recognize the driving axis of which a driving mode is changed by the operation image 32. In addition, an operation of setting the driving mode can be facilitated.

In the above-described embodiment, one driving mode is set based on the operation on the operation image 32. However, a plurality of driving modes may be set based on the operation on the operation image 32.

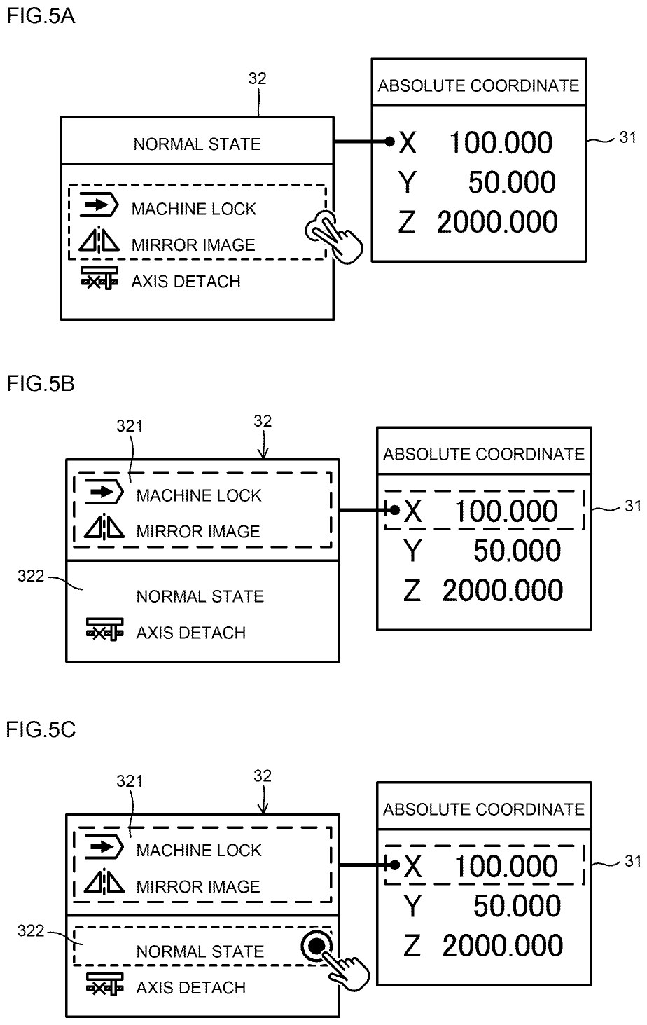

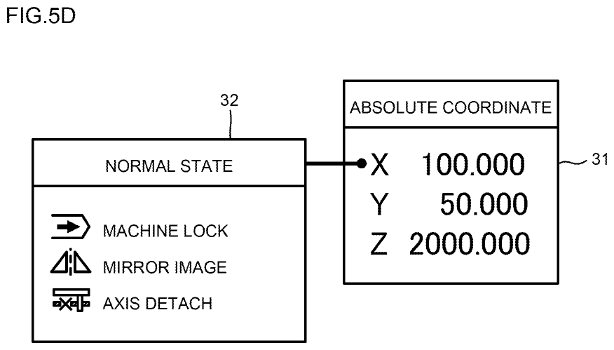

FIG. 5A is a diagram illustrating an example of the operation on the operation image 32. FIG. 5A illustrates that the characters “machine lock” and the characters “mirror image” are simultaneously touched.

When the characters “machine lock” and the characters “mirror image” are touched, the image display unit 211 changes a background of these characters, for example, from gray to yellow.

When a finger is separated from the display screen 30 after a predetermined time has elapsed in a state in which the characters “machine lock” and the characters “mirror image” are touched, the image display unit 211 displays the touched characters “machine lock” and “mirror image” in the setting mode display region 321. In other words, when the detection unit 212 detects a long press operation on the characters “machine lock” and the characters “mirror image”, the image display unit 211 displays the touched characters “machine lock” and the characters “mirror image” in the setting mode display region 321.

FIG. 5B is a diagram illustrating an example of the operation image 32 and the driving axis information image 31. FIG. 5B illustrates the operation image 32 and the driving axis information image 31 after the long press operation is performed on the characters “machine lock” and the characters “mirror image”. The characters “machine lock” and the characters “mirror image” subjected to the long press operation by the operator are displayed in the setting mode display region 321. Meanwhile, the characters “normal state” are displayed in the candidate image display region 322.

The image display unit 211 highlights and displays the image displayed in the setting mode display region 321. Highlight display may be a display mode in which an image subjected to the touch operation and an image not subjected to the touch operation are distinguished from each other. For example, the image display unit 211 displays a background of the image displayed in the setting mode display region 321 in green. In this way, the operator can easily recognize the set driving mode.

In addition, when the set driving mode is a driving mode other than the normal mode, the image display unit 211 highlights and displays an axis name and coordinate values of a driving axis set to the mode other than the normal mode. The image display unit 211 displays a background of the axis name and the coordinate values of the driving axis in green.

The determination unit 213 determines a driving mode based on an operation on the operation image 32. The determination unit 213 determines a driving mode to be set based on a touch operation on the display screen 30 detected by the detection unit 212. For example, as illustrated in FIG. 5A and FIG. 5B, when the detection unit 212 detects a touch operation on the characters “machine lock” and “mirror image”, the determination unit 213 determines to set the driving mode to the machine lock mode and the mirror image mode.

Note that when the driving mode is set to the normal mode again, a touch operation is performed on the characters “normal state” displayed in the candidate image display region 322.

FIG. 5C is a diagram illustrating an example of an operation on the operation image 32. FIG. 5C illustrates that a touch operation is performed on the characters “normal state”. When the characters “normal state” are touched, for example, the image display unit 211 changes the background of the candidate image display region 322 from gray to yellow.

When a finger is separated from the display screen 30 after a predetermined time has elapsed in a state in which the characters “normal state” are touched, the image display unit 211 displays the touched characters “normal state” in the setting mode display region 321. In other words, when the detection unit 212 detects a long press operation on the characters “normal state”, the image display unit 211 displays the characters “normal state” subjected to the touch operation in the setting mode display region 321.

FIG. 5D is a diagram illustrating an example of the operation image 32 and the driving axis information image 31. FIG. 5D illustrates the operation image 32 and the driving axis information image 31 after a long press operation is performed on the characters “normal state”. The characters “normal state” subjected to the long press operation by the operator are displayed in the setting mode display region 321. Meanwhile, the characters “machine lock” and the characters “mirror image” are displayed in the candidate image display region 322.

In the case of displaying the characters “normal state” in the setting mode display region 321, for example, the image display unit 211 displays the background of the setting mode display region 321 in white. In addition, in the case of displaying the characters “machine lock” and “mirror image” in the candidate image display region 322, the image display unit 211 cancels highlight display of the characters “machine lock” and “mirror image”. That is, the image display unit 211 returns a background of the characters “machine lock” and “mirror image” displayed in the candidate image display region 322 to gray.

In the above-described embodiment, a driving mode of one driving axis is changed based on an operation on the driving axis information image 31. However, driving modes of a plurality of driving axes may be changed based on the operation on the driving axis information image 31.

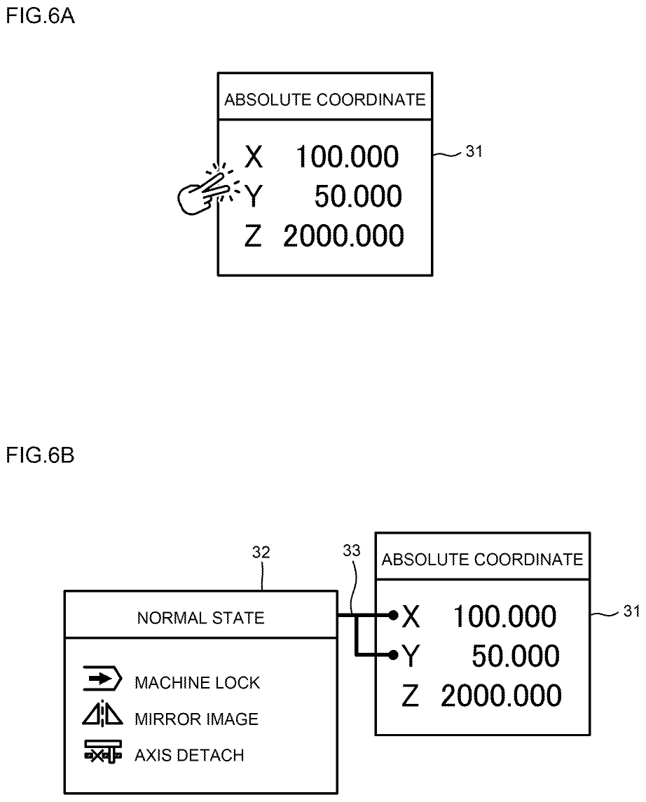

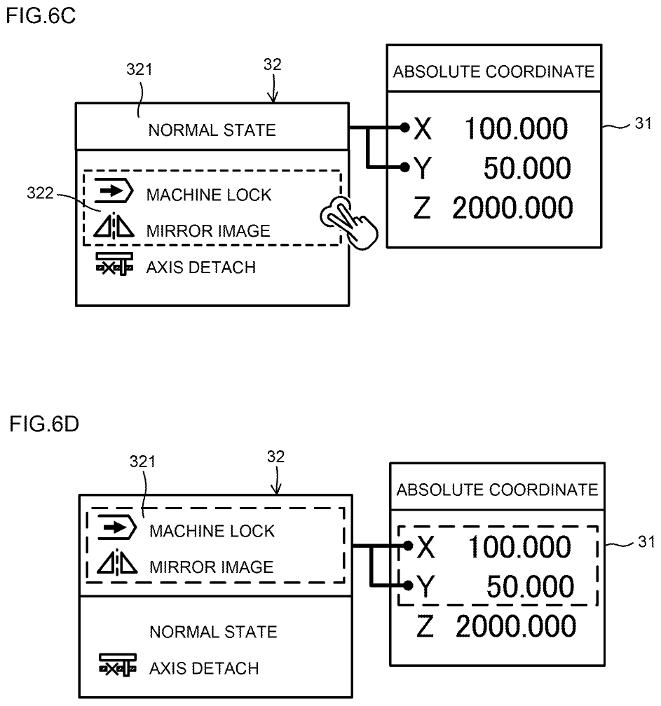

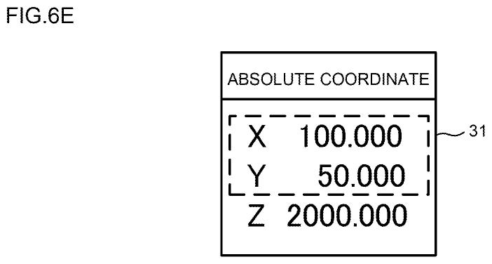

FIG. 6A is a diagram illustrating an example of the driving axis information image 31. The detection unit 212 detects a touch operation on a portion indicating a name of a driving axis in the driving axis information image 31. For example, the detection unit 212 detects a touch operation on a plurality of regions indicating names of driving axes. For example, the touch operation on the plurality of regions is an operation of simultaneously tapping on regions, in which characters “X” and “Y” indicating names of the X-axis and the Y-axis, respectively, are displayed, using two fingers.

When the detection unit 212 detects a touch operation on the characters “X” and “Y” in a state in which the same driving mode is set for the X-axis and the Y-axis, the image display unit 211 displays the operation image 32 and the axis specification image 33 on the display screen 30.

FIG. 6B is a diagram illustrating an example of the operation image 32 and the axis specification image 33. In the example illustrated in FIG. 6B, both the X-axis and the Y-axis are set to the normal mode.

The axis specification image 33 specifies a driving axis subjected to mode change. In the example illustrated in FIG. 6B, the axis specification image 33 is a line that extends leftward in the horizontal direction from each of positions of the characters “X” and “Y” of the driving axis information image 31 and is connected to the setting mode display region 321. The detection unit 212 detects a touch operation on an image displayed in the candidate image display region 322.

FIG. 6C is a diagram illustrating an example of an operation on the operation image 32. FIG. 6C illustrates that the characters “machine lock” and “mirror image” are simultaneously touched. When the characters “machine lock” and “mirror image” are touched, the image display unit 211 changes the background of these characters, for example, from gray to yellow.

When a finger is separated from the display screen 30 after a predetermined time has elapsed in a state in which the characters “machine lock” and “mirror image” are touched, the image display unit 211 displays the touched characters “machine lock” and “mirror image” in the setting mode display region 321. In other words, when the detection unit 212 detects a long press operation on the characters “machine lock” and “mirror image”, the image display unit 211 displays the touched characters “machine lock” and “mirror image” in the setting mode display region 321.

FIG. 6D is a diagram illustrating an example of the operation image 32 and the axis specification image 33. FIG. 6D illustrates the operation image 32 and the driving axis information image 31 after a long press operation is performed on the characters “machine lock” and “mirror image”. The characters “machine lock” and “mirror image” subjected to the long press operation by the operator are displayed in the setting mode display region 321. Meanwhile, the characters “normal state” are displayed in the candidate image display region 322.

The image display unit 211 highlights and displays the image displayed in the setting mode display region 321. For example, the image display unit 211 displays a background of the image displayed in the setting mode display region 321 in green.

In addition, when the set driving mode is a driving mode other than the normal mode, the image display unit 211 highlights and displays an axis name and coordinate values of a driving axis set to the mode other than the normal mode. In the example illustrated in FIG. 6D, the axis names and the coordinate values of the X-axis and the Y-axis are highlighted and displayed, respectively. When the detection unit 212 detects a touch operation on the characters “machine lock” and “mirror image”, the determination unit 213 determines to change the driving mode to the machine lock mode and the mirror image mode.

When the operation of eliminating the operation image 32 is performed, or when there is no operation on the operation image 32 for a predetermined time, the determination unit 213 determines to hide the operation image 32.

FIG. 6E is a diagram illustrating an example of the driving axis information image 31. As described above, when the driving mode of the X-axis and the Y-axis is set to a driving mode other than the normal mode, highlight display of a display region of the axis name and the coordinate values of the X-axis and the Y-axis in the driving axis information image 31 is maintained. That is, even when the operation image 32 is eliminated, the image display unit 211 maintains highlight display in the driving axis information image 31. In this way, the operator can easily recognize that the driving mode of the X-axis and the Y-axis is set to a mode other than the normal mode.

The disclosure is not limited to the above embodiments, and can be modified as appropriate without departing from the scope of the disclosure. In the disclosure, modification of any component of the embodiments or omission of any component of the embodiments is possible.

### EXPLANATIONS OF LETTERS OR NUMERALS

1 INDUSTRIAL MACHINE
2 CONTROLLER
201 CPU
202 BUS
203 ROM
204 RAM
205 NONVOLATILE MEMORY
206 INTERFACE
207 AXIS CONTROL CIRCUIT
208 SPINDLE CONTROL CIRCUIT
209 PLC
210 I/O UNIT
211 IMAGE DISPLAY UNIT
212 DETECTION UNIT
213 DETERMINATION UNIT
214 CONTROL UNIT
3 INPUT/OUTPUT DEVICE
30 DISPLAY SCREEN
31 DRIVING AXIS INFORMATION IMAGE
32 OPERATION IMAGE
321 SETTING MODE DISPLAY REGION
322 CANDIDATE IMAGE DISPLAY REGION
33 AXIS SPECIFICATION IMAGE
4 SERVO AMPLIFIER
5 SERVOMOTOR
6 SPINDLE AMPLIFIER
7 SPINDLE MOTOR
8 AUXILIARY DEVICE

1. A controller comprising:
an image display unit configured to display an operation image for changing a driving mode of a driving axis on a display screen;
a determination unit configured to determine the driving mode based on an operation on the operation image; and
a control unit configured to control the driving axis based on the driving mode determined by the determination unit.

2. The controller according to claim 1, further comprising a detection unit configured to detect a touch operation on the display screen,
wherein, when the detection unit detects the touch operation, the image display unit displays the operation image on the display screen.

3. The controller according to claim 2, wherein:
the image display unit further displays a driving axis information image indicating driving axis information of the driving axis; and
when the detection unit detects the touch operation on the driving axis information image, the image display unit displays the operation image on the display screen.

4. The controller according to claim 3, wherein the image display unit changes a display mode of the driving axis information image based on the driving mode determined by the determination unit.

5. The controller according to claim 3, wherein the image display unit displays the operation image adjacent to the driving axis information image.

6. The controller according to claim 1, wherein, when an operation of eliminating the operation image is performed, or when there is no operation on the operation image for a predetermined time, the determination unit determines to hide the operation image.

7. The controller according to claim 1, wherein the determination unit determines the driving mode to be at least one of a normal mode, a machine lock mode, a mirror image mode, an axis detach mode, an interlock mode, and a servo off mode.

8. The controller according to claim 1, wherein the operation image includes an axis specification image for specifying the driving axis and an image indicating a candidate for the driving mode.

9. The controller according to claim 8, wherein the determination unit determines the driving mode of the driving axis based on an operation on the image indicating the candidate.
